(19) United States
(12) Patent Application Publication
(10) Pub. No.: US 2006/0122866 A1
(43) Pub. Date: Jun. 8, 2006

(54) Medication compliance system and method

(75) Inventors: John Hadl, Beverly Hills, CA (US); Geoff Weg, Venice, CA (US)

Correspondence Address: MAYER, BROWN, ROWE & MAW LLP, P.O. BOX 2828, CHICAGO, IL, 60690-2828, US

(73) Assignee: Creative Rx Solutions, LLC

(21) Appl. No.: 11/286,630

(22) Filed: Nov. 23, 2005

Related U.S. Application Data
(60) Provisional application No. 60/630,965, filed on Nov. 24, 2004.

(51) Int. Cl. G06Q 10/00; G06F 17/30; G08B 23/00

(52) U.S. Cl. 705/2; 707/1; 340/573.1

(57) ABSTRACT

A system and method for procuring increased medication compliance having at least an inbound functionality and an outbound functionality. The inbound functionality allows a patient to contact the system and request information regarding a particular medication and the outbound functionality preferably provides at least a reminder system. Preferably, the system and method for procuring improved medication compliance provides personalized and engaging content, while enabling a participating service providers to segment their consumer population, and tailor a specific message to their customers.

### PRIORITY

This application claims the benefit of U.S. Provisional Application No. 60/630,965, filed Nov. 24, 2004.

### FIELD OF THE INVENTION

The present invention relates to a system and method for procuring improved medication compliance by consumers in the health care industry.

### BACKGROUND OF THE INVENTION

In the health care industry, a common problem is the failure of patients to follow a prescribed prescription regimen by: (i) failing to initially fill a prescription; (ii) not taking medication after filling a prescription; (iii) taking less medication per dose than a prescription requires; and/or (iv) terminating use of a medication prior to the end of a prescription regimen. These patients are commonly referred to as “non-compliant” patients. In fact, among other things, it is believed that:
12% of patients never fill their initial prescriptions;
12% of patients don't take the medication after filling a prescription;
22% of patients take less medication per dose than their prescription instructs; and
29% of Americans stop taking the prescribed medication before the prescription runs out.

A failure to follow a prescription regimen can have dire consequences. For example, improper prescription compliance can result in disease persistence and higher death rates. Additionally, increased direct and indirect health care costs can be attributed to “non-compliant” patients, such as increased hospital and nursing home admissions and lost patient productivity at work. Further, studies show that “non-compliant” patients cost the pharmaceutical industry billions of dollars each year in lost sales due to unfilled or under-filled prescriptions.

There are a variety of factors that affect patient compliance with a prescription regimen. Some of these factors include: psychological, behavioral, and lifestyle issues; cost; insurance coverage; combination of conditions and related prescriptions; effectiveness of the medication on the patient condition (positive or negative); and a patient's understanding of his/her condition and the treatment regimen. Thus, for example, a patient may stop taking a medication if the side effects are deemed adverse or if the patient does not perceive any benefits from the particular medication, even though the medication must be taken for a specified period of time before any positive effects can be noticed. Moreover, the effects of some medication, for instance cholesterol reducing medication, cannot be observed unless a blood test is taken.

Accordingly, because of at least the above-described issues, there remains a need for a system and method to increase medication compliance. A preferred embodiment of the present invention addresses these issues through a personalized interactive communication system that preferably has three major components: (i) an information component; (ii) a support component; and (iii) a reminder component. A patient preferably will enroll in the system, provide requested medical information and other personal information, and based on the patient's profile, will receive basic information, emotional support, medication reminders, or some combination of the above. One embodiment of the system provides for access through a toll-free number and personal identification number that will initiate the patient's account. Access to the toll-free number can be provided in any number of ways, including by way of a calling card or paper printout that is distributed by physician's office, by a pharmacy when a patient picks up a prescription, through direct mailings from managed care organizations or through a web site.

Upon calling the system, the patient will hear a voice recording, preferably recorded by a celebrity, of a spokesperson who uses the same medication (and has the same condition) as the patient. This voice recording will provide an introduction explaining, among other things, the benefits of taking the medication and a brief outline of the system. After the introduction, the spokesperson offers the user a full list of features to choose from, which generally will fall under one of three categories: information, support and reminders.

The information provided by the system relates to the drug itself, the benefits of prescription compliance, frequently asked questions and the spokesperson's experiences with the particular condition and medication. Support is provided through a peer support forum where stories from a community of peers can be recorded, heard and shared. Lastly, the reminder aspect of the system provides two kinds of reminders: (i) regular medication reminders; and (ii) prescription fill reminders. These reminders can be customized to each patient based on questions asked by the system and answered by the patient, and can be updated at any time. Moreover, the reminders can be sent in a variety of ways, including by telephone, email, and/or text messaging (i.e., SMS) and image messaging (i.e., MMS). These reminders can be send to any number of communication devices, including telephones, computers, cell phones and pagers.

Thus, a preferred embodiment of the present invention is designed to improve patient compliance by emphasizing the benefits of prescription compliance, addressing obstacles to adherence and providing support, education and encouragement with an appealing, personalized approach.

### SUMMARY OF THE INVENTION

A system and method for procuring increased medication compliance having at least an inbound functionality and an outbound functionality. Preferably, the inbound functionality allows a patient to contact the system and request information regarding a particular medication and the outbound functionality provides a medication reminder system. Preferably, the system and method for procuring improved medication compliance provides personalized and engaging content, while enabling a participating service providers to segment their consumer population, and tailor a specific message to their customers.

### BRIEF DESCRIPTION OF THE DRAWINGS

This invention will be more fully understood by reference to the following drawings, which are provided for illustrative purposes only:

FIG. 1 illustrates one preferred embodiment of a customer calling card.

FIG. 2 is a flow diagram illustrating a menu hierarchy of the inventive system and method.

FIGS. 3-10 are pages of a demonstrative script, detailing potential responses a user would hear as he or she progresses through the inventive system and method.

FIG. 11 is a technological overview for implementing the inventive system and method.

FIG. 12 is one embodiment of an interactive voice recording architecture.

FIG. 13 is one embodiment of a mobile messaging system.

FIG. 14 is one embodiment of a mobile messaging system.

### DESCRIPTION OF THE PREFERRED EMBODIMENT

While the present invention is capable of embodiment in various forms, there is shown in the drawings and described herein will hereinafter be described as a preferred embodiment with the understanding that the present disclosure is to be considered an exemplification of the invention, and is not intended to limit the invention to the specific embodiments illustrated.

The present invention provides a customized and interactive information, support and reminder system for pharmaceutical consumers that communicates with patients across a variety of media. Patients, through a variety of touch points, will be invited to participate in the inventive medication compliance system through a particular mode of communication, such as calling a toll-free phone number or logging onto a website. Once the patient communicates an interest in the medication compliance system by calling in or logging on, among other methods, the patient would enter a code or personal identification number (“PIN”), which will initiate the patient's account.

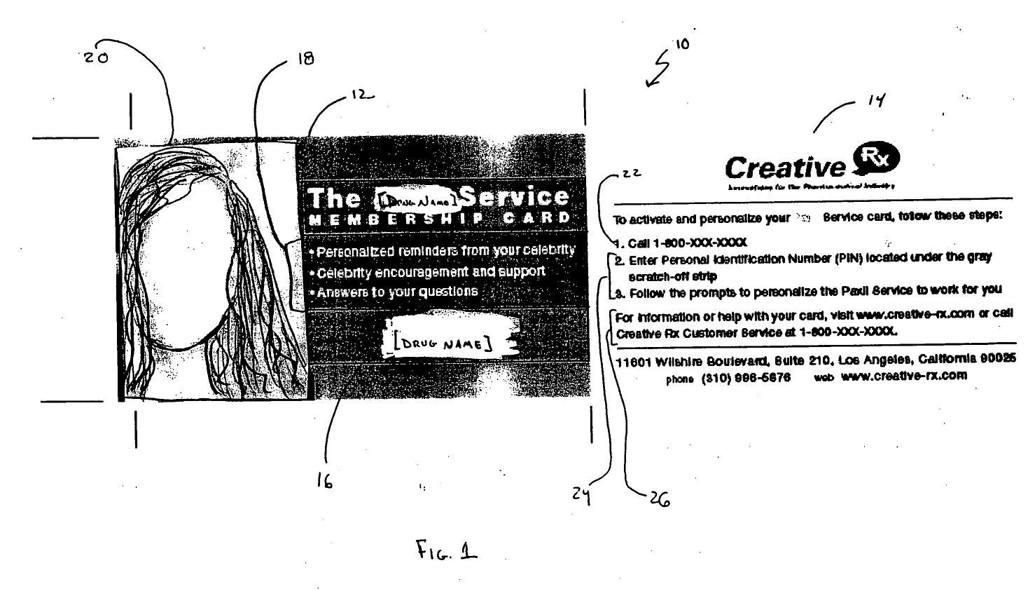

The patient may receive the phone number, website address or other contact information through any one of several potential methods. Referring to FIG. 1, one method of inviting patients to use the inventive system is to provide a patient with a calling card 10. The calling card, or other information source, preferably has a front side 12 and a back side 14. The front side 12 preferably displays the drug name 16, a summary of the features of the compliance system 18 and preferably includes a likeness of the designated spokesperson or participating celebrity for that service 20. The back side of the calling card preferably contains a toll-free number for activating and personalizing the system 22, instructions for activating and personalizing the system 24 and other information for customer service 26. Other information that may be displayed on either the front or the back side of the calling card 10 includes: product logos, advertising, pharmacy information, and/or spokesperson information. It will be appreciated that the contact information could also be distributed by way of a paper printout, brochure, or other informational objects.

Further, the calling card 10, printout, or other invitation may be distributed in a variety of ways. For example, the patient may receive the invitation at the physician's office at the time they receive a prescription, either directly from the physician or an assistant, as a starter kit insert, or as a sample pack insert. The calling card 10 or other invitation may also be delivered by the pharmacist when the patient picks up their prescription. Another method for inviting a patient to enroll in the service is a mailing from a participating pharmacy chain, MCO or PBM. Finally, patients may enroll via a website or call the toll-free number directly upon seeing direct-to-consumer advertising of the drug.

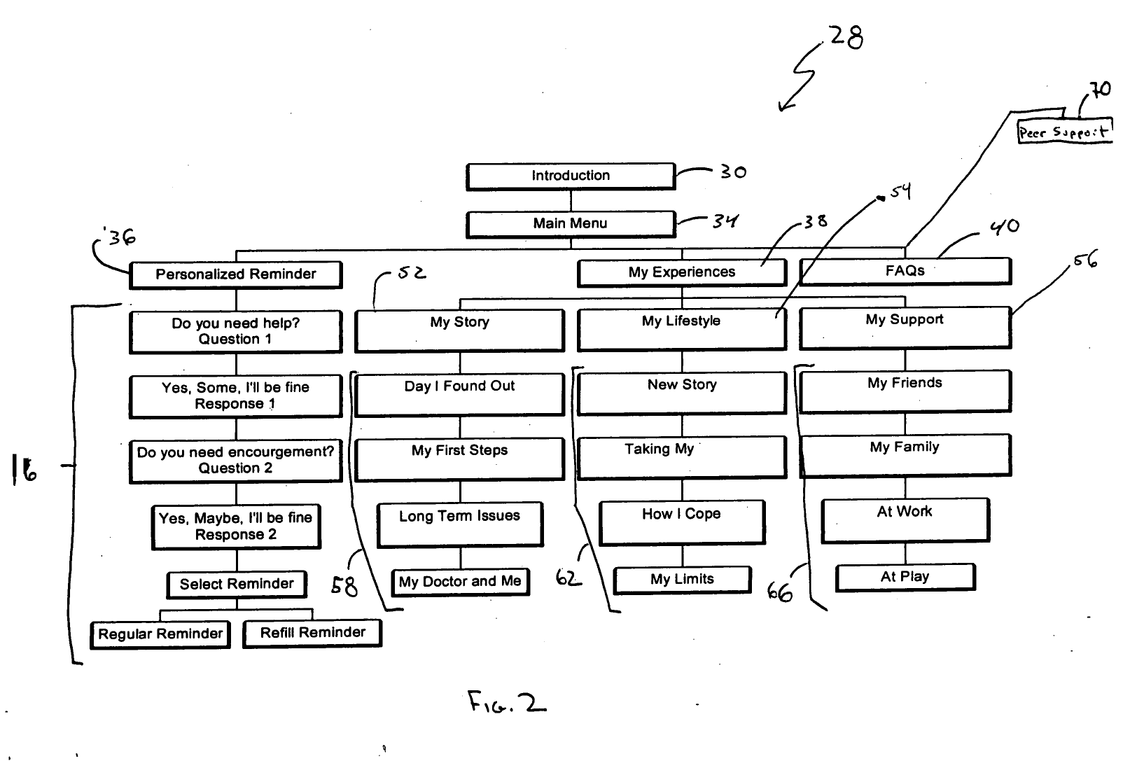

FIG. 2, shows an interactive voice response (“IVR”) menu hierarchy 28 for use with one embodiment of the invention. Upon service enrollment by using the toll-free number and pin, the patient will interact with the system through a series of prompts to create a personal profile. Based on the information provided and requested by the patient in this personal profile, the patient will receive information, support, reminders, or some combination of the same, customized to the patient's location, gender, race, age, health condition, or any number of additional factors.

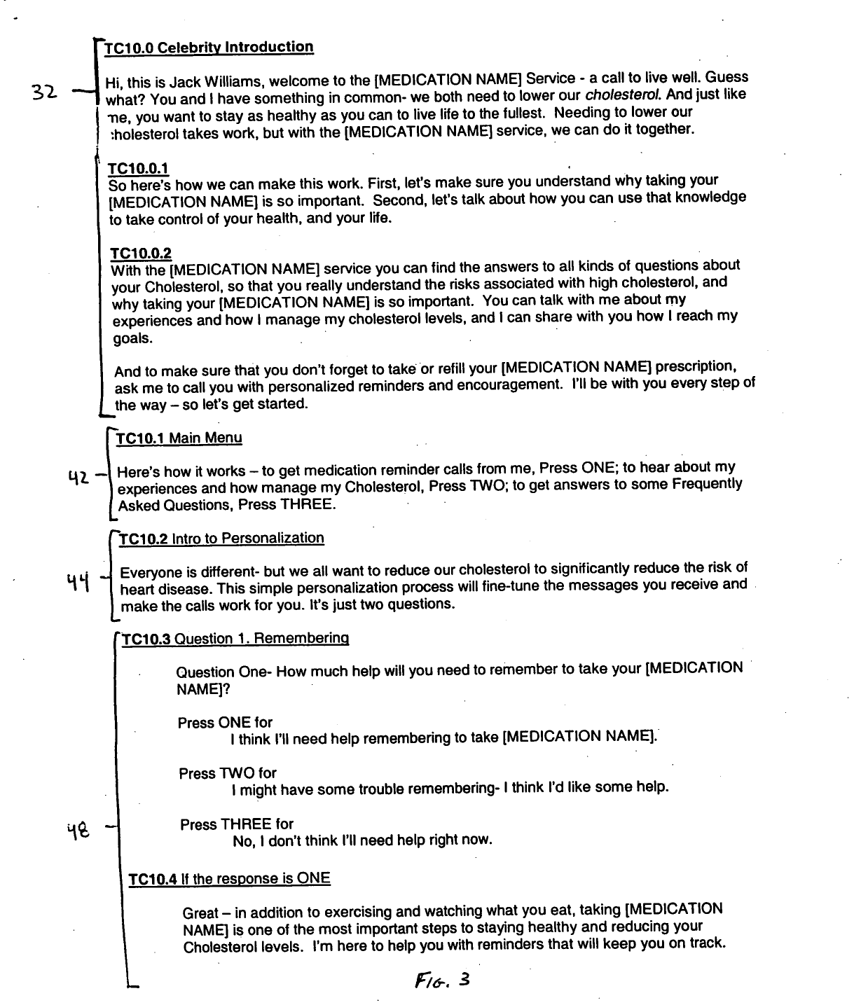

Referring now to FIGS. 2 and 3, in one preferred embodiment, a new patient will be exposed to an introduction 30 by a spokesperson, who may be a celebrity, a doctor, or a pharmacist, among others, and may be chosen by the patient. This introduction works to create an emotional connection between the patient and the spokesperson, because the spokesperson will explain that s/he and the patient both live with the same condition and both want to stay healthy and live life to the fullest. The introduction emphasizes the importance of understanding the need to take their medication in order to take control of their health, and can also highlight the medication brand and/or participating retailer at issue for the patient. A sample script for such an introduction is shown in FIG. 3 as reference number 32.

Next, the introduction is followed by an option menu 34 that contains a brief outline of the service options, which preferably include options to elect personalized medication reminders 36, experiences 38 and frequently asked questions 40. This option menu offers the patient a full list of features to choose from, in any of a number of ways, including simply by pressing or saying a number on their telephone. A sample script for the menu and personalization introduction are shown on FIG. 3 as reference numbers 42 and 44, respectively.

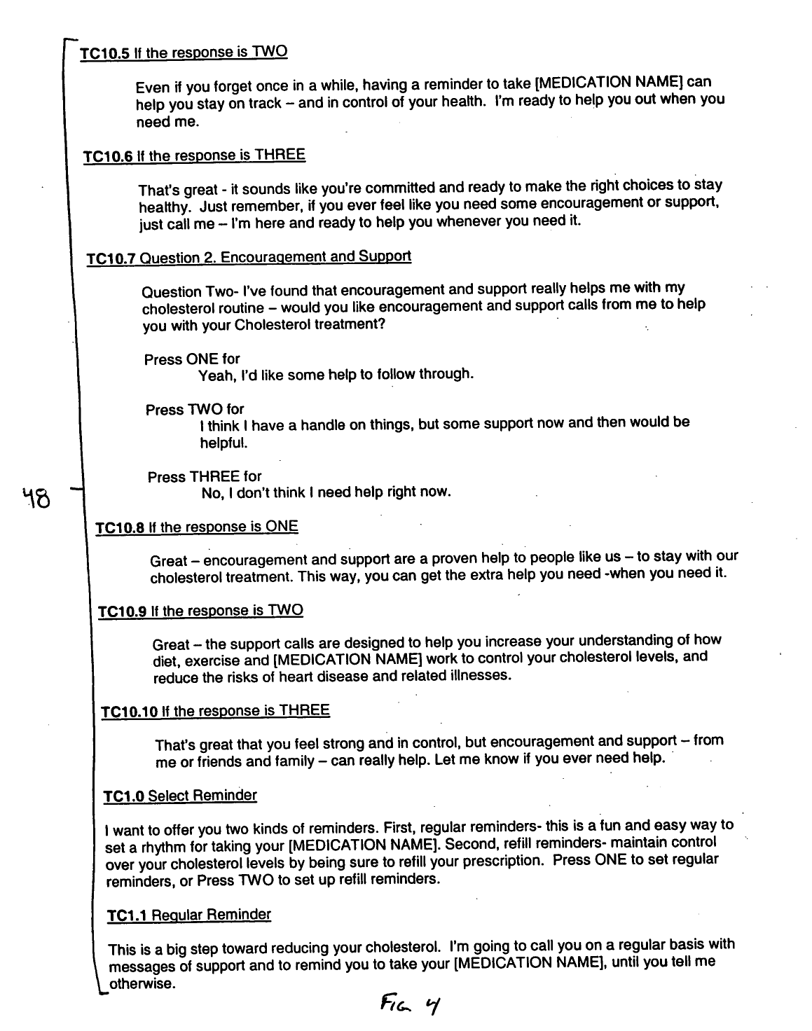

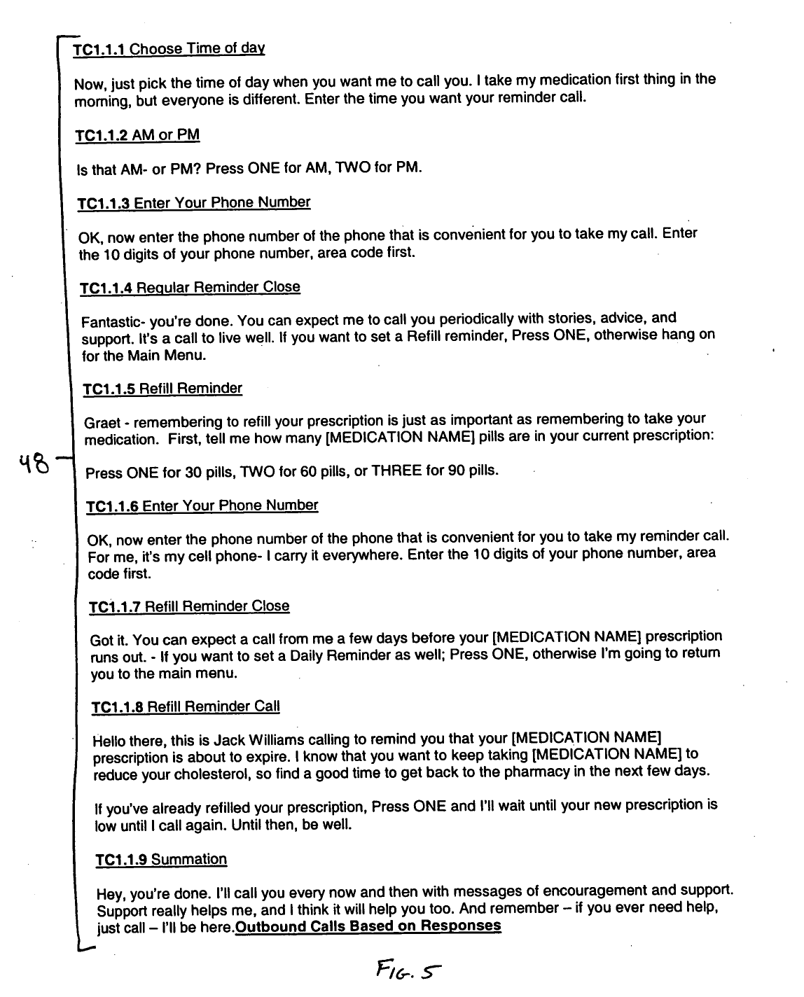

If a patient selects personalized medication reminders 36, the patient will preferably be prompted by the system to provide the system with the patient's desired levels and types of reminders, as shown in FIG. 2 as reference numeral 46. At least two types of reminders are provided by the system of the present invention—regular reminders and refill reminders. Regular reminders to take a particular medication according to the frequency set by the patient are designed to provide support and encouragement to patients to stick to their prescription regimen. Refill reminders will be less frequent than the regular reminders, and are designed to motivate patients to refill their prescriptions promptly. Upon choosing to receive regular and/or refill reminders, the patient will be prompted to answer a short series of questions designed to identify and address any issues that might prevent the patient from taking their medication. The patient may also be asked general demographic questions. Based upon the patient's responses, the service can adjust the timing, tone and content of the reminder and encouragement calls to suit the patient's individual needs, thereby personalizing the service. Further, the service can offer patients a variety of different messaging choices based upon patients inputs and responses. The scripts for the various prompts regarding reminders are shown in FIGS. 3-5 as reference number 48.

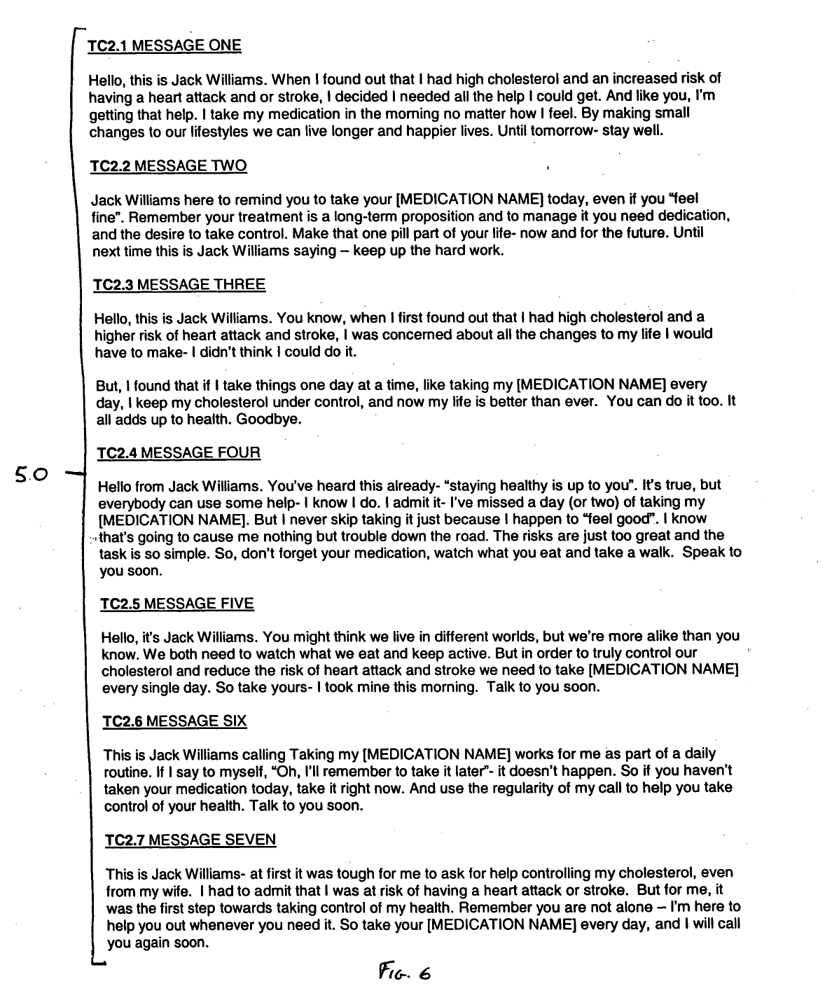

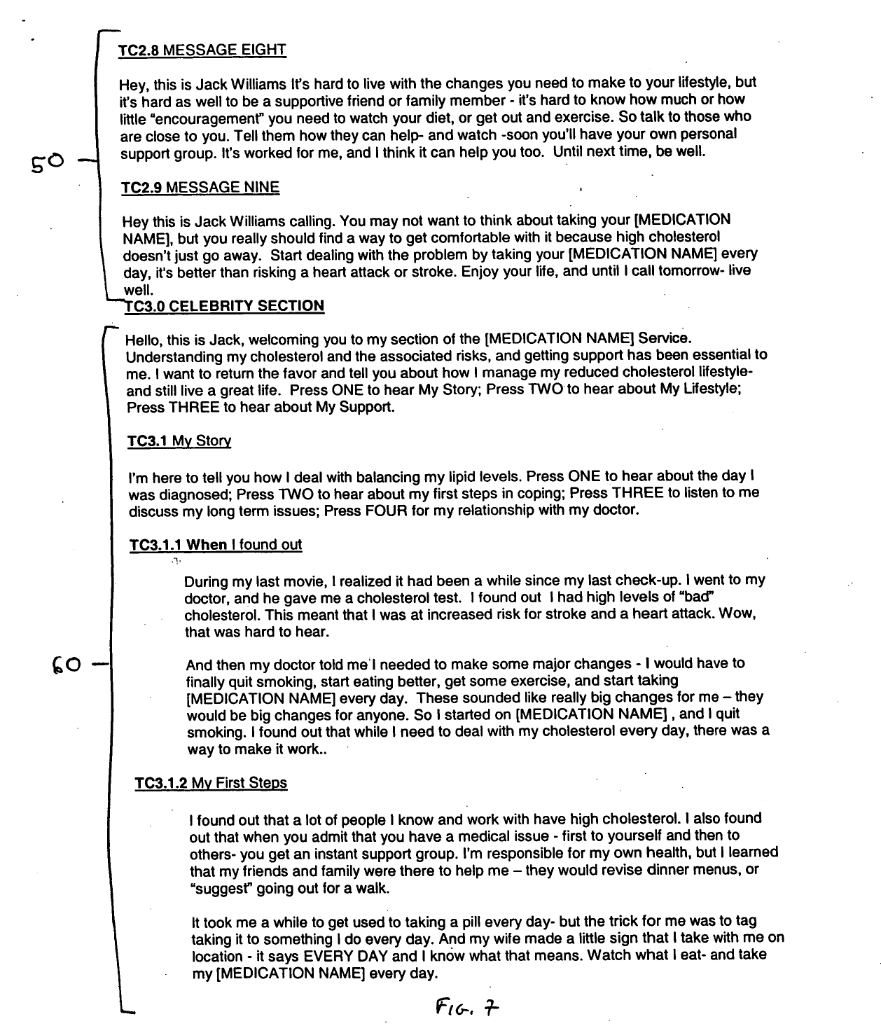

The system will store all of the information provided by the patient and communicate reminders and encouragement to the patient, as often and in the manner the patient has chosen. These reminders can be delivered by way of phone call, voice message, text message, email, picture message, or any other type of communication method and can be delivered at the time the medication must be taken, when it is time for a prescription to be refilled, or at other times the patient desires. Example scripts for outbound reminder and encouragement calls are shown in FIGS. 6-7 as reference number 50. The flexibility provided by this system provides patients with options to suit their own needs and lifestyles. Additionally, by allowing for interactive communication via a customized variety of media channels, pharmaceutical manufacturers are afforded the benefits of personalized and direct marketing opportunities to end consumers.

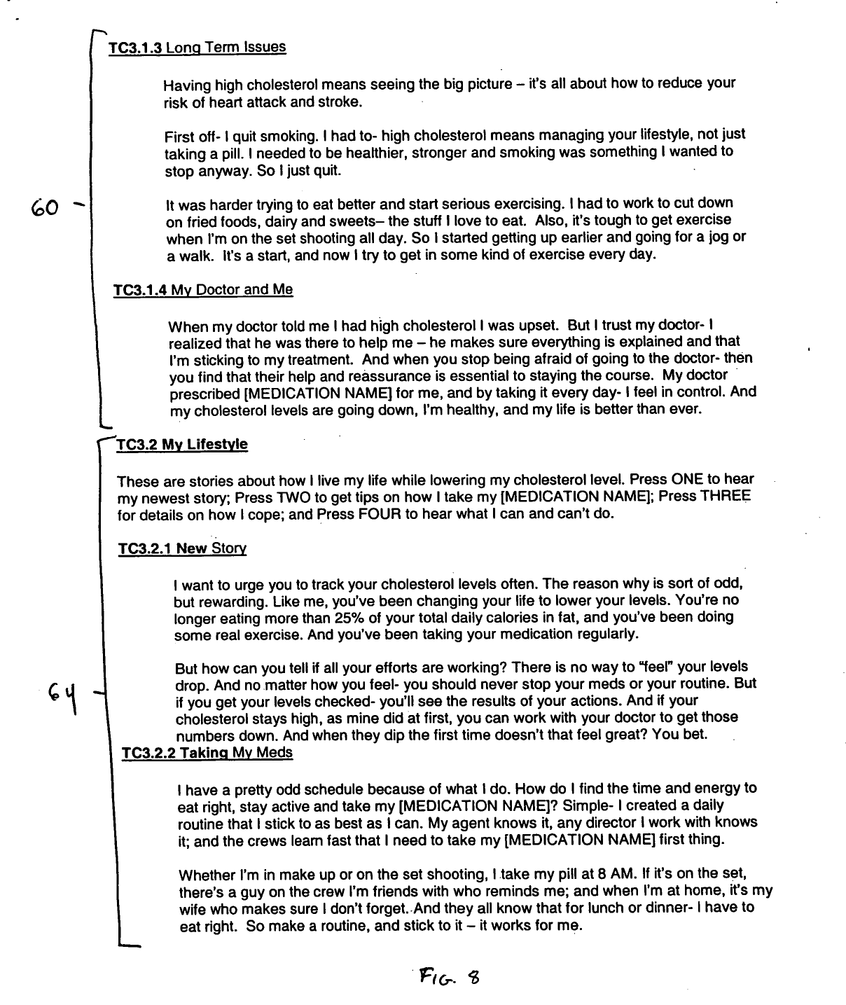

If a patient selects the experiences menu 38 of the system, the patient will preferably be presented with a spokesperson's experiences with the particular medication and will have the option to hear about the spokespersons' story 52, lifestyle 54 or support 56, as shown in FIG. 2. This part of the system allows a patient to learn about a spokesperson's condition history in the form of a testimonial, which outlines the spokesperson's experience with the particular condition and details how they found encouragement and solutions. Preferably, the stories will be upbeat and give tangible details about the issues that everyone faces—what they did when they were diagnosed, how they turned to friends and family for support, and how the spokesperson understands that taking their medication, and refilling their prescription, were the solutions to taking control of their health and their life. For example, when a patient chooses to hear a spokesperson's story 52, the patient will be provided with upbeat testimonials from the spokesperson regarding how s/he was diagnosed with a particular ailment/condition, the steps taken to address this ailment/condition, long term issues and the spokesperson's relationship with his/her doctor, as shown in FIG. 2 as reference numeral 58. Preferred scripts for such items are shown in FIGS. 7-8 as reference number 60.

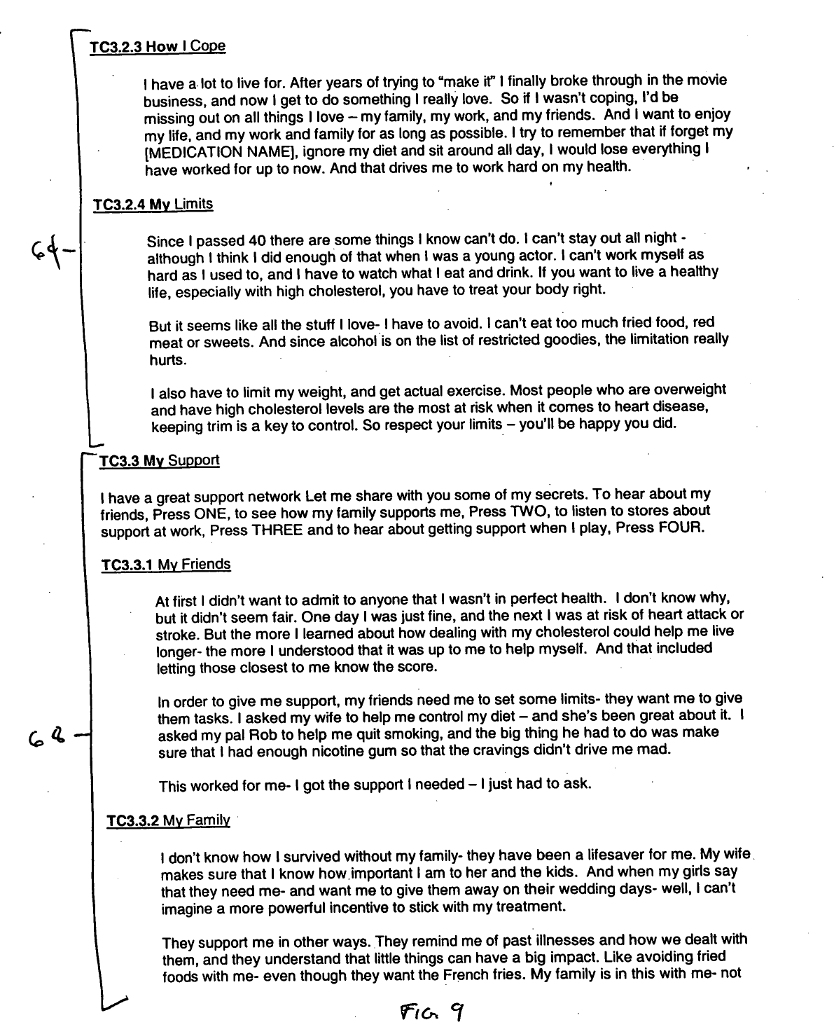

If a patient chooses to hear about the spokesperson's lifestyle 54, a preferred embodiment of the system will provide the patient with access to details about the spokesperson's life with a focus on how the spokesperson copes with their condition on a daily basis. The spokesperson will explain that they are like anyone with the burden of a medical condition, and that with perseverance and support the patient, like the spokesperson, can take charge of their health and live a full and happy life. These stories will allow patients a glimpse into the life of the spokesperson to further strengthen the emotional connection between patient and spokesperson. Upcoming public events and other news can be a light touch added to the information and medical detail, further personalizing the information provided by the system to the patient based on location, age, gender, race, religion, or other supplied information. In one embodiment of the invention, the lifestyle 54 section of the system provides a patient with new stories from the spokesperson, how that spokesperson takes his/her medication, how the spokesperson copes with taking the medication and the limits that the spokesperson may have, as shown as reference number 62 in FIG. 2. Illustrative scripts for such items are shown in FIGS. 8-9 as reference number 64.

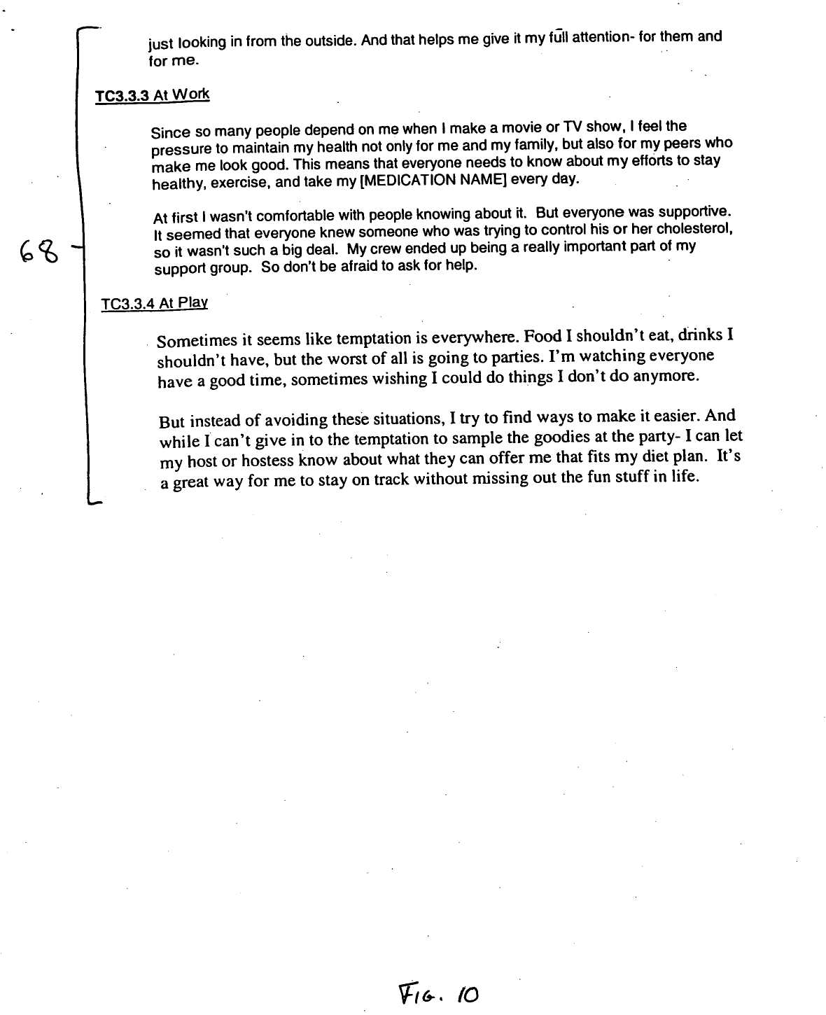

If a patient selects the support 56 portion of the system, the patient will preferably be presented with options to hear about the spokespersons' support network, friends, family, work relations, and how that spokesperson maintains his/her regimen at play, as shown as reference number 66 in FIG. 2. Sample scripts for such items are shown as reference number 68 in FIGS. 9-10. If a patient select the frequently asked questions portion 40 of the system, the patient will be prompted with questions designed to focus the information desired. The patient will then be supplied with appropriate responses in the form of answers to frequently asked questions, or general background information about the medication or condition. Generally speaking, this section will offer content similar to the information on a manufacturer's website, and may include the benefits of taking one's medication properly, information regarding diet and exercise, and general information on the patient's particular condition.

A preferred embodiment will also include a peer support 70 option for the patient, which option may also be chosen from the main menu 34 or may alternatively be provided in other sections of the menu hierarchy, such as the support menu 56. This option provides a forum where, among other things, stories from a community of peers can be recorded, heard and shared. The environment will be a way for patients to hear from others with information relating to the medical condition or medication, allowing access to a living knowledge base of stories and common experiences. New stories will be highlighted, and patients will be able to hear about people with similar backgrounds and experiences to discover what others have learned, felt or have gained from their lives. Patients can also sign-up to receive new stories on a periodic basis.

As will be appreciated by those with skill in the art the menu hierarchy shown in FIG. 2 and the related scripts shown in FIGS. 3-10 are merely preferred embodiments of the present invention and that other menu hierarchies and scripts can be used in the practice of the present invention. Moreover, although an IVR system is used in a preferred embodiment of the present invention, it will be appreciated that any other type of communication method with a patient can be used in the practice of the present invention.

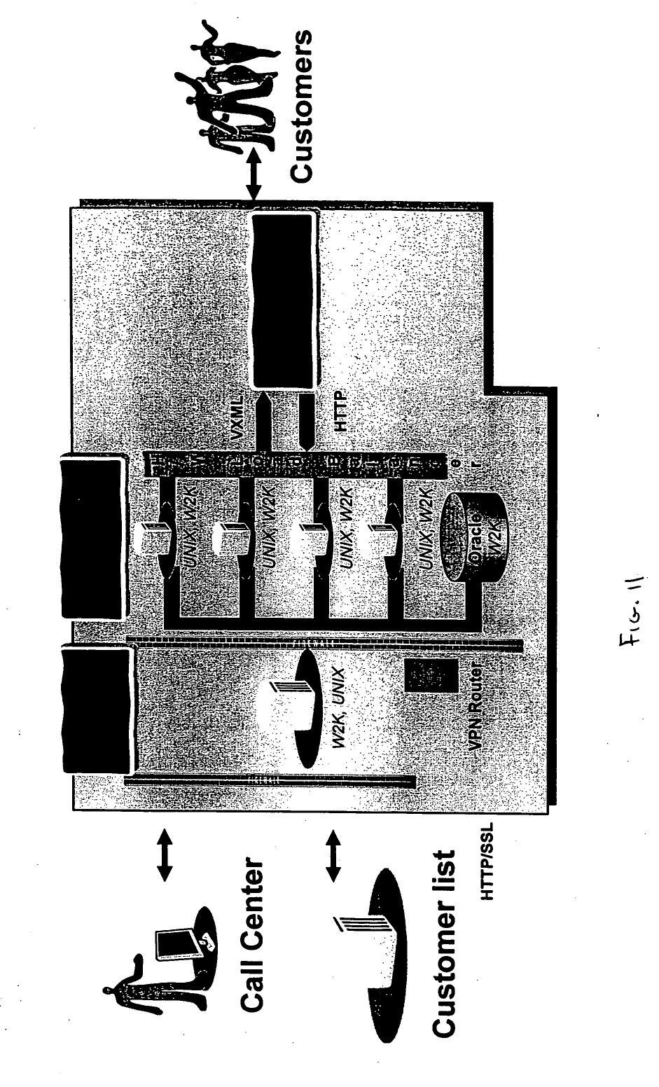

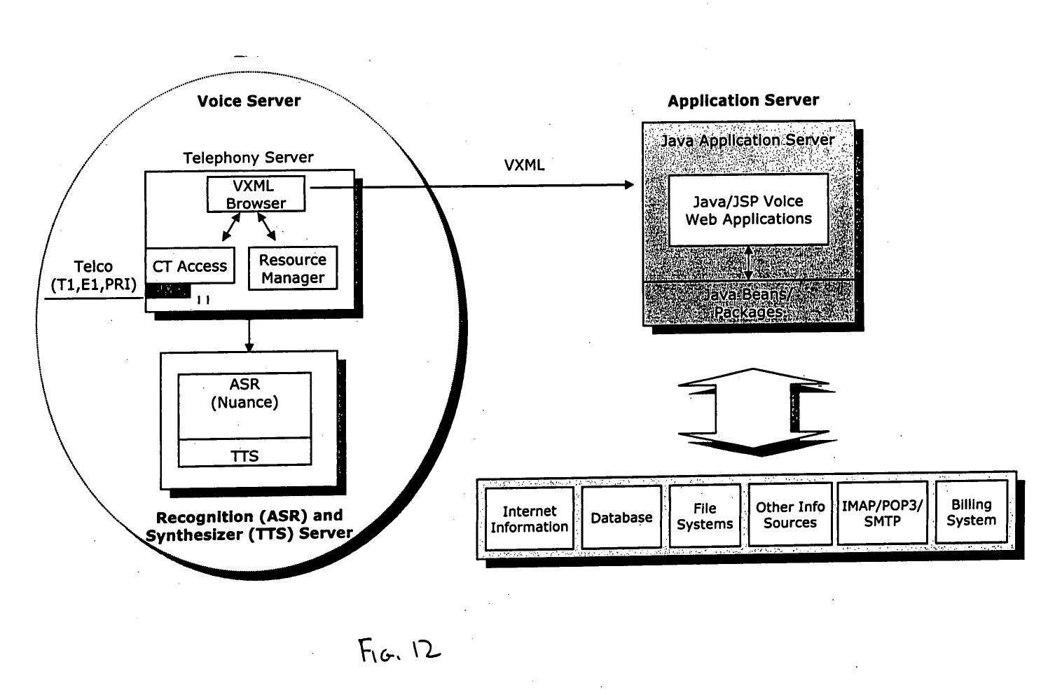

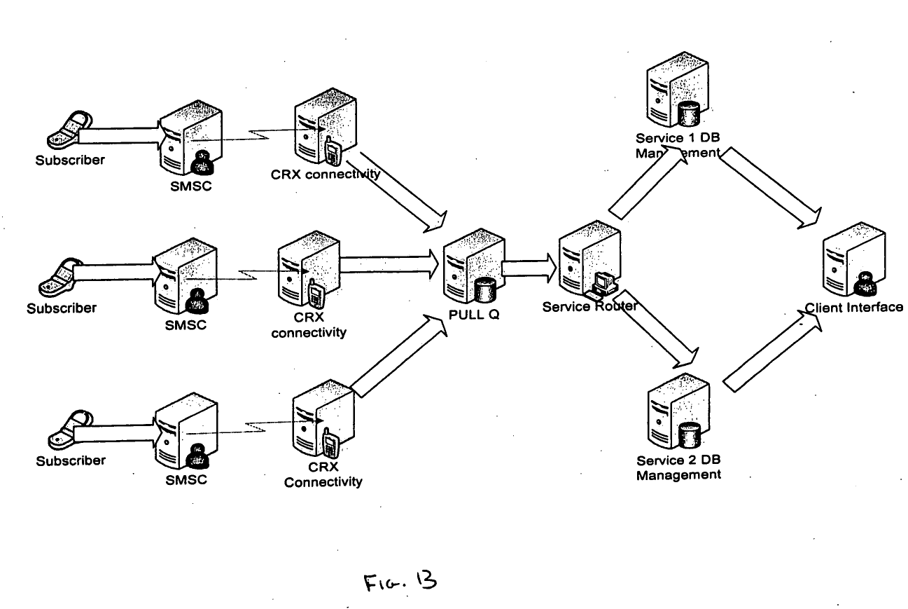

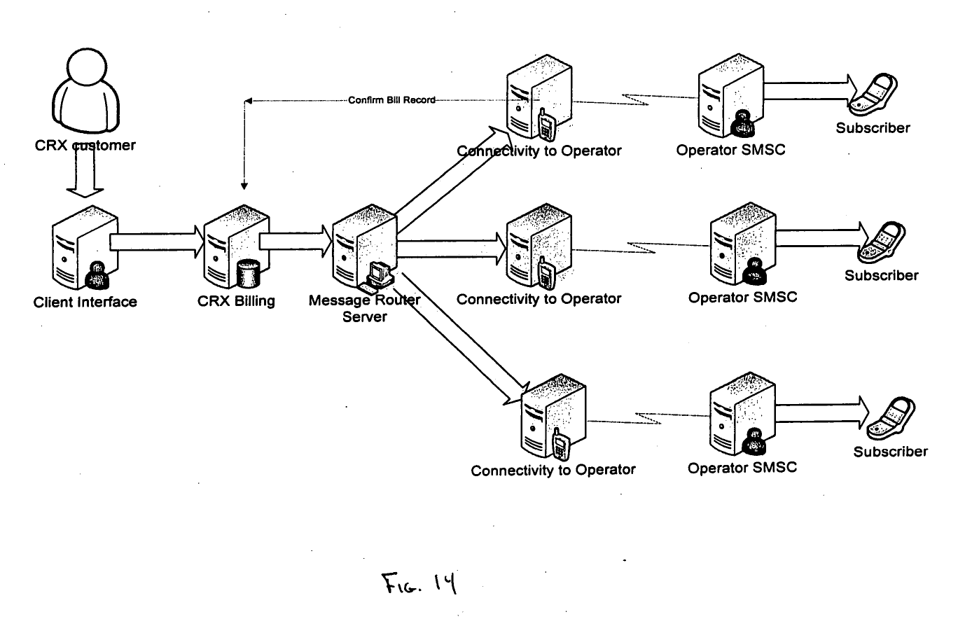

FIG. 11 shows an exemplary deployment overview for implementing one embodiment of the present invention. FIG. 12 shows an exemplary IVR architecture for implementing one embodiment of the present invention. FIG. 13 shows an exemplary mobile messaging MT distribution scheme for one embodiment of the present invention. FIG. 14 shows an exemplary mobile messaging MO distribution scheme for one embodiment of the present invention.

The foregoing description of a preferred embodiment of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined by the claims set forth below.

What is claimed is:

1. A medication compliance system comprising:
at least one outbound functionality and at least one inbound functionality;
a patient profile for storing patient information, said patent profile being created when a patient accesses the system and provides the system with information;
wherein said inbound functionality comprises the functionality of allowing a patient to contact the system and request information and wherein said outbound functionality comprises the functionality of providing communications to a patient.

2. The medication compliance system of claim 1, wherein said access to the system by a patient is provided by an IVR system.

3. The medication compliance system of claim 1, wherein said communications are provided by text messaging a patient.

4. The medication compliance system of claim 1, wherein said communications are provided by image messaging a patient.

5. The medication compliance system of claim 1, wherein said communications comprise reminders to take a medication.

6. The medication compliance system of claim 1, wherein said communications comprise reminders to refill a prescription.

7. The medication compliance system of claim 1, wherein said inbound functionality further comprises allowing a patient to contact the system and request support.

8. A method of increasing compliance with a medication regimen comprising:
enrolling a patient in a system;
requesting information from said patient;
providing communications to a patient, as requested by a patient.

9. The method of claim 8, wherein said communications are provided through text messaging.

10. The method of claim 8, wherein said communications are provided through image messaging.

11. The method of claim 8, wherein said communications are reminders to take medication.

12. The method of claim 8, wherein said communications are reminders to refill a prescription.

13. The method of claim 8, further comprising providing support to patients.

14. The method of claim 8, wherein said system is an IVR system.
